(19) United States
(12) Patent Application Publication
(10) Pub. No.: US 2006/0005030 A1
(43) Pub. Date: Jan. 5, 2006

(54) System and method for managing copyright information of electronic content

(75) Inventor: Peter Kassan, Dobbs Ferry, NY (US)

Correspondence Address: OSTROLENK FABER GERB & SOFFEN, 1180 AVENUE OF THE AMERICAS, NEW YORK, NY, 100368403, US

(73) Assignee: Web Bindery LLC

(21) Appl. No.: 11/204,059

(22) Filed: Aug. 15, 2005

Related U.S. Application Data
(63) Continuation-in-part of application No. 11/199,358, filed on Aug. 8, 2005.
Application No. 11/199,358 is a continuation-in-part of application No. 11/193,716, filed on Jul. 29, 2005.
Application No. 11/193,716 is a continuation of application No. 10/671,194, filed on Sep. 25, 2003.
(60) Provisional application No. 60/460,352, filed on Apr. 3, 2003.
(60) Provisional application No. 60/601,532, filed on Aug. 13, 2004.

(51) Int. Cl. H04L 9/00

(52) U.S. Cl. 713/176

(57) ABSTRACT

The present invention improves the way information related to copyright of electronic content, such as virtual documents and corresponding formatted print pages is received, managed, and distributed. A database is preferably provided that stores information regarding electronic content, such as virtual documents, formatted print pages, and related copyright information. Preferably, information regarding a virtual document is correlated with related information in the database, such as regarding a copyright holder. Other information about the virtual document, such as a copyright arrangement for the particular document, payment due information, or the like, is similarly related to virtual documents.

### CROSS-REFERENCE TO RELATED APPLICATION

This patent application is a continuation-in-part of U.S. patent application Ser. No. 11/199,358 filed Aug. 8,2005 and entitled SYSTEM AND METHOD FOR VIRTUAL PRINT DEVICES FOR COMMAND IMPLEMENTATION, which is a continuation-in-part of U.S. patent application Ser. No. 11/193,716 filed Jul. 29, 2005 and entitled IMPROVED SYSTEM AND METHOD FOR PROVIDING FORMATTED PRINT PAGES, which is a continuation-in-part of Ser. No. 10/671,194 filed Sep. 25, 2003 and entitled SYSTEM FOR PRODUCING ONLINE CONTENT FROM WEB SITES ON DEMAND, which claims priority to U.S. Provisional Patent Application, Ser. No. 60/460,352, filed on Apr. 3, 2003 and entitled “SYSTEM FOR PRODUCING MAGAZINES FROM WEB SITES ON DEMAND,” and is further based on and claims priority to U.S. Provisional Patent Application, Ser. No. 60/601,532, filed on Aug. 13, 2004 and entitled “SYSTEM AND METHOD FOR PRODUCING FORMATTED PRINT PAGES (III),” the entire contents of all of which are hereby incorporated herein by reference.

### BACKGROUND OF THE INVENTION

1. Field of the Invention

The present invention relates generally to virtual documents and, more particularly, to copyright data associated with virtual documents and/or electronic content.

2. Description of the Related Art

Virtually all content provided in electronic form, such as on computer systems and made available over the internet, is copyrighted. In accordance with U.S. law, copyright protection extends to original expression that is fixed in a tangible form, such as on a computer, that is not in the public domain. Furthermore, much of the copyrighted content that is provided in electronic form is registered with the United States Copyright Office. Unfortunately for many copyright owners, providing copyrighted material in electronic form has increased the ability for unauthorized copies to be made and distributed, and no form of remuneration is realized.

Referring to the drawings in which like reference numerals refer to like elements, FIG. 1 shows an example prior art hardware arrangement for viewing, reviewing and outputting internet web site content. As shown in FIG. 1, an internet web server 2 provides electronic content 3 to a user terminal 4 that communicates with the web server 2 via communication network 16. Content 3 can include, for example, text, graphics, pictorial, audio and video material. The user terminal 4 preferably employs software that enables a communication session to be established between the user terminal 4 and the web server 2. Preferably, the web server 2 employs software enabling a communication session, for example an HTTP session, to be established between the user terminal 4 and the web server 2. Also as shown in FIG. 1, a printer 7 is preferably controlled by user terminal 4 to provide printed output of content 3. For example, after a person views content 3 on user terminal 4 using typical web browser software, the person selects an option to print the content 3 on printer 7.

Co-pending U.S. patent applications Ser. Nos. 11/199,358, 11/193,716 and 10/671,194, assigned to the assignee of the present invention, describe a system and method for providing formatted print pages of electronic content 3. In one embodiment, a request is received for formatted print pages related to content 3 provided one or more internet web sites. After the request is received, a layout is applied for the content 3 and electronic production information representing instructions for fulfilling the request is transmitted to a fulfillment facility where the formatted print pages are generated and delivered to the requester. In another embodiment, the electronic content 3 is stored on the user's hard drive or over a private network.

A need exists in the industry for an improved way to enable requestors and providers of formatted print pages to monitor and manage information related to copyrights of electronic content 3 and corresponding formatted print pages. Owners of copyrighted material that is produced in the form of formatted print pages want to realize financial gain therefrom. Providers of formatted print pages need to monitor copyright information and ensure that no copyright infringement is caused by reproducing copyrighted material. Moreover, consumers want to receive formatted print pages that the consumer receives with confidence that the formatted print pages do not infringe an author's copyright.

### SUMMARY OF THE INVENTION

The present invention addresses shortcomings in the prior art by improving the way information related to copyrights of electronic content 3, virtual documents and corresponding formatted print pages is collected, managed and distributed.

The present invention improves the way information related to copyright of electronic content 3, such as virtual documents and corresponding formatted print pages is received, managed, and distributed. A database is preferably provided that stores information regarding electronic content 3, such as virtual documents, formatted print pages, and related copyright information. Preferably, information regarding a virtual document is correlated with related information in the database, such as regarding a copyright holder. Other information about the virtual document, such as a copyright arrangement for the particular document, payment due information, or the like similarly related to virtual documents is stored and referenced.

In a preferred embodiment, the present invention comprises a system and method for securing authorization to include at least some of copyrighted content in electronic or physical form. The invention comprises storing in a database electronic information regarding electronic and physical content. A request is received for the electronic or physical form that includes the at least some of the first content. Moreover, a determination is made whether the electronic information includes permission to include the at least some of the first content; and the electronic or physical form is preferably provided when the electronic information includes permission to include at least some of the first content.

In an alternative embodiment, the invention further comprises requesting permission to provide the electronic or physical form when the electronic information does not include permission to include at least some of the first content.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an prior art hardware arrangement for viewing, reviewing and outputting internet web site content 3;

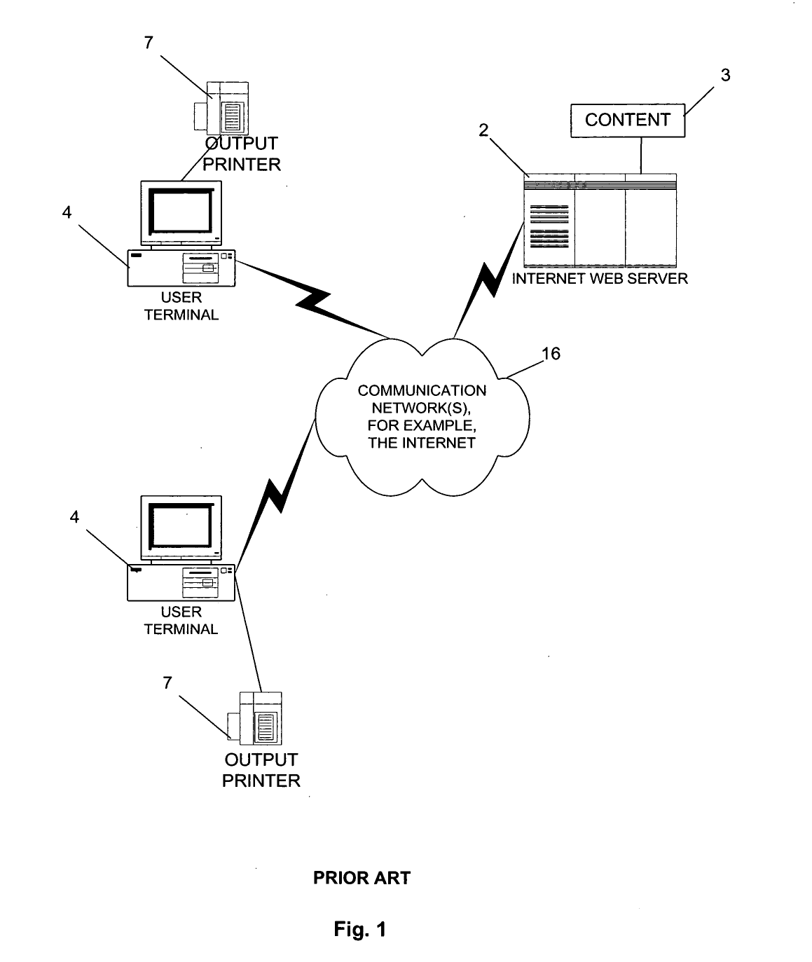

FIG. 2 shows an example hardware arrangement in a preferred embodiment of the present invention;

FIG. 3 illustrates the functional elements of a user terminal;

FIG. 4 illustrates an example layout of database tables in accordance with an example embodiment;

FIG. 5 illustrates an example display screen 500 that is provided to a user who requests formatted print pages;

FIG. 6 illustrates an example display screen which is provided to a copyright owner or authorized agent thereof in order to receive authorization for producing formatted print pages of copyrighted material; and

FIG. 7 is a flow chart that illustrates example steps associated with a preferred embodiment.

### DESCRIPTION OF THE PREFERRED EMBODIMENT

The present invention improves the way information related to copyright of electronic content 3, virtual documents and corresponding formatted print documents is received, managed, and distributed. In a preferred embodiment of the present invention, information regarding copyrights, including information concerning a relationship between a service provider and a copyright holder is stored in a database. Preferably, the invention electronically correlates a virtual document with information in the database, such as regarding a copyright holder, and provides additional information about the virtual document, such as a copyright arrangement for the particular document, payment due information, or the like. Preferably, the present invention also stores recording or other use information. For example, the invention monitors and stores how many times a particular document has been printed, how much money has been collected from customers, how many times and how much money was distributed to a copyright owner, and so forth.

As used herein, the term, “module” refers, generally, to one or more discrete components that contribute to the effectiveness of the present invention. Modules can operate or, alternatively, depend upon one or more other modules in order to function.

Also as used herein, the term “virtual document,” refers generally, to a file that, when processed by appropriate software running on an appropriate device, is displayed on a display device in a way that suggests, imitates, simulates, or emulates the appearance of a real, physical document. Also as used herein, a “virtual document” is not the file itself but a display of a file. Virtual documents include, for example, word processing documents, spreadsheet files, digital images and the like.

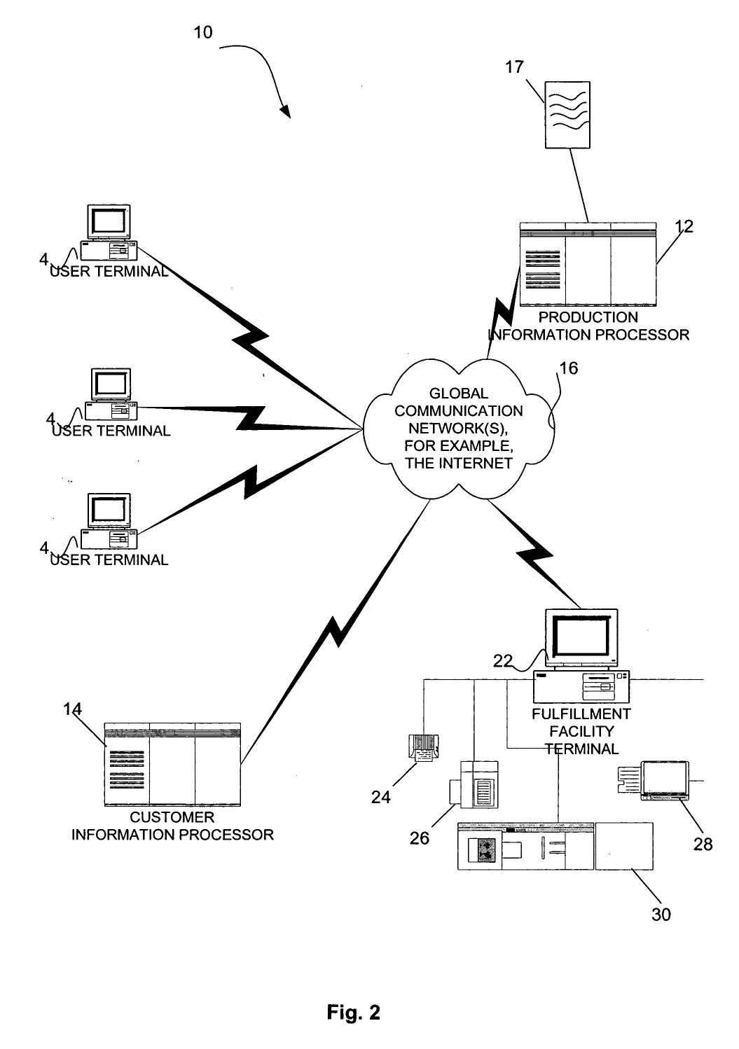

FIG. 2 shows an example hardware arrangement in a preferred embodiment of the present invention, including a hardware arrangement for providing formatted print pages, and referred to generally as system 10. The electronic content 3 for the formatted print pages may be web-based, as described in co-pending U.S. patent application, Ser. No. 10/671,194, or, alternatively, may be from content 3 stored on a so-called locally installed drive or over a private network. In the embodiment shown in FIG. 2, system 10 comprises at least one production information processor 12, and at least one customer information processor 14 and adapted to access communication network 16. Each of the production information processor 12 and the customer information processor 14 preferably provide respective internet web sites that includes content 3 information for respective visitors, substantially as described in co-pending U.S. patent application, Ser. No. 10/671,194.

Also as shown in FIG. 2, a fulfillment facility terminal 22 communicates with at least the production information processor 12 and receives instructions with respect to a request for printed forms of content 3. Although the embodiment shown in FIG. 2 identifies the fulfillment facility terminal 22 separate from the production information processor 12, the fulfillment facility terminal 22 can be under the direct control of the proprietor of the production information processor 12.

In the example shown in FIG. 2, fulfillment facility terminal 22 preferably includes a formatted print output printer 24. In addition to the formatted print output printer 24, one or more other devices are preferably provided and used in accordance with the present invention. For example, a fulfillment facility terminal 22 employs a binding machine 28 to combine individual sheets. Further, a saddle stitch machine 30 may be provided to provide a professional appearance for the printed output. Further, a folding machine 26 may be employed by the fulfillment facility terminal 22 in order to prepare signatures, i.e., sets of one or more sheets for binding. As shown in FIG. 2, the output related devices, including, the folding machine 26, binding machine 28, and saddle stitch machine 30 are presented as separate and apart from the formatted print output printer 24. Of course, one skilled in the art will recognize that two or more of these devices may be integrated into a single device.

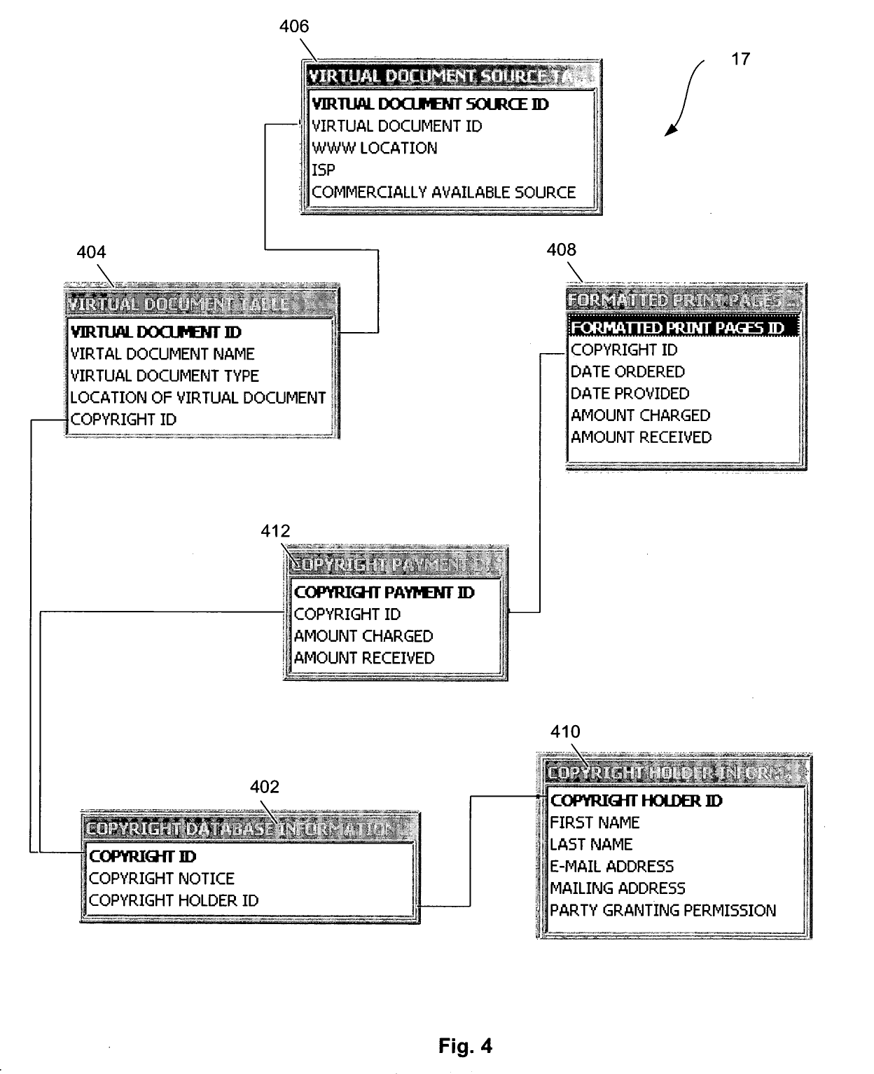

In the preferred embodiment, information processor 12 maintains copyright database 17 which includes one or more databases of information related to the teachings herein. Although the embodiment shown in FIG. 2 illustrates database 17 on information processor 12, one skilled in the art will recognize that database 17 may be stored and/or operated on any on or plurality of devices. For example, customer information processor 14 and/or user terminal 4 may access database 17 to add, update or retrieve information to/from database 17. As note above, examples of information stored in copyright database 17 include information regarding copyright holders, internet service providers, recording and use of copyrighted material, and financial payments for copies and/or formatted print pages of copyrighted material. An embodiment of database 17 is more fully described with reference to FIG. 4.

Continuing with the example hardware arrangement illustrated in FIG. 2, user terminals 4, production information processor 12 and customer information processor 14 are any devices that are capable of sending and receiving data across communication network 16, e.g., mainframe computers, mini computers, personal computers, laptop computers, a personal digital assistants (PDA) and internet access devices such as Web TV. In addition, production information processors 12 and customer information processors 14 are preferably equipped with a web browser, such as MICROSOFT INTERNET EXPLORER, NETSCAPE NAVIGATOR and the like.

The nature of the present invention is such that one skilled in the art of writing computer executable code (i.e., software) can implement the described functions using one or more of a combination of popular computer programming languages and developing environments including, but not limited to C, C++, Visual Basic, JAVA, HTML, XML, ACTIVE SERVER PAGES, JAVA server pages, servlets, and a plurality web site development applications.

For example, data may be configured as an MICROSOFT EXCEL spreadsheet file, as a comma delimited ASCII (American Standard Code for Information Interchange) text file, as a MICROSOFT SQL SERVER compatible table file, or the like. In another embodiment, data may be formatted as in image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. For example, an image file may be received over a communication network that includes copyright information. The copyright information is preferably automatically determined and stored in copyright database 17. In another example, data are received that are provided in format (e.g., MICROSOFT EXCEL), and programming routines are executed that convert the data to another formatted (e.g., ASCII comma-delimited text).

It is contemplated herein that any suitable operating system can be used on user terminal 4, production information processor 12 and customer information processor 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS POCKET PC and any other suitable operating system.

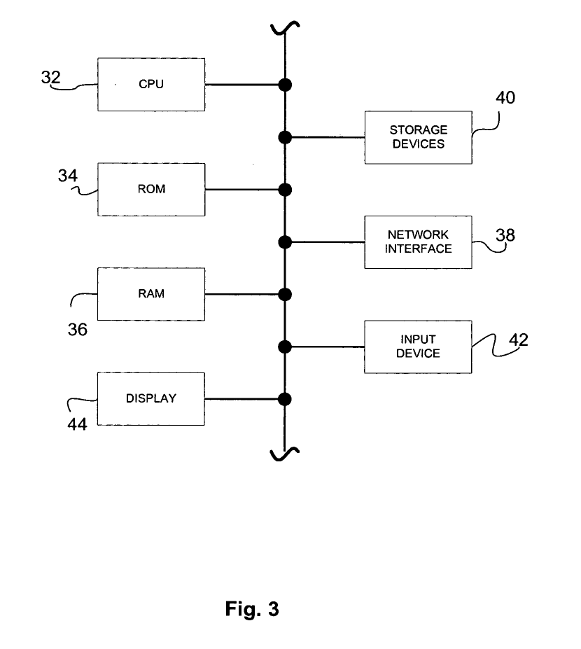

FIG. 3 illustrates the functional elements of user terminal 4, production information processor 12 and/or customer information processor 14 and include one or more central processing units (CPU) 32 used to execute software code and control the operation of user terminal 4, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code, databases and application data, one or more input devices 42 such as a keyboard, mouse, track ball, microphone and the like, and a display 44.

The various components of user terminal 4 need not be physically contained within the same chassis or even located in a single location. For example, storage device 40 may be located at a site which is remote from the remaining elements of production user terminal 4, and may even be connected to CPU 32 across communication network 16 via network interface 38. Production information processor 12 preferably includes a memory equipped with sufficient storage to provide the necessary databases, forums, and other community services as well as acting as a web server for communicating hypertext markup language (HTML), Java applets, Active-X control programs or the like to customer information processors 14. Production information processors 12 are arranged with components, for example, those shown in FIG. 3, suitable for the expected operating environment of production information processor 12. The CPU(s) 32, network interface(s) 38 and memory and storage devices are selected to ensure that capacities are arranged to accommodate expected demand.

In a preferred embodiment, one or more modules are preferably provided that determine whether a virtual document requested to be provided as formatted print pages is associated with a stored record in database 17. For example, a database record representing copyright ownership of a virtual document is stored in a table. When a request is made for formatted print pages of the virtual document, the database record associated with the virtual document is referenced and a user is informed thereof. Thus, the invention preferably includes programming that enables making such an association.

FIG. 4 illustrates an example layout of database tables comprising database 17 in accordance with an embodiment. One skilled in the art will recognize that the embodiment shown in FIG. 4 is illustrative and that many other tables, table formats and other kinds of information are envisioned herein, which can be added or substituted to comprise database 17. The lines connecting the tables in FIG. 4 represent how the tables interact, for example, as a function of data fields that are common to a plurality of tables.

Continuing with the example in FIG. 4, six example tables are illustrated: copyright database information table 402, virtual document table 404, virtual document source table 406, formatted print pages table 408, copyright holder information table 410 and copyright payment data table 412. Copyright database table 402 includes data fields directed to copyright notice information and copyright holders. Virtual document table 404 includes data fields directed to virtual documents and/or content 3 a user desires to be provided as formatted print pages. Virtual document source table 406 includes data fields for storing information related to locations (e.g., electronic or physical) where virtual documents are stored and/or available. Formatted print pages 408 includes data fields directed to formatted print pages of virtual documents. In the example shown in FIG. 4, formatted print pages table 408 includes data fields for copyright information, respective dates that formatted print pages are ordered and received, and financial amounts charged and received for formatted print pages. Copyright holder table 410 includes information directed to copyright holders and/or authorized agents thereof. For example, copyright holder table 410 includes data fields for name, e-mail and physical addresses, or the like. Copyright payment data table 412 preferably stores information directed to financial amounts charged and/or received for reproducing copyrighted material. For example, an owner of a copyright in an particular digital image of a bird charges $12.00 per copy. Such information is preferably stored in copyright payment data table 412.

Thus, the example collection of tables illustrated in FIG. 4 represent one embodiment of copyright database 17. The tables are preferably joined by common fields and, in accordance with the teachings herein, software programs operate to retrieve, add, delete and/or update information stored in the tables. Further, the present invention preferably includes automatically creating a record in the database 17 and adding information regarding copyright holders that are not already listed in the database. Also, preferably, a way for determining copyright information for a virtual document, for example, by using heuristics or other methods to find a copyright notice is provided. For example, a search for a reference regarding copyright is made. The search may be for information formatted as ASCII text, or, alternatively, may be for information provided in some other format. For example, an electronic image may comprise a copyright notice. In accordance with the teachings herein, software routines are preferably executed to locate such a copyright notice. In one embodiment, a process referred to in the art as “screen scraping” is performed and copyright information is determined thereby. Any suitable technique known to one skilled to extract information from an electronic file is envisioned herein.

Preferably, the invention matches copyright holder information provided in the virtual document with a database of copyright holders, for example, by using heuristics or other methods, to identify matches between the database records and the copyright holder information. Preferably, matching technique(s) can incorporate both exact and partial matches.

In a preferred embodiment, when a user selects a graphic screen control, such as a button, to initiate a request for formatted print pages, the present invention establishes a communication session with the party or parties responsible for permitting reproduction of copyrighted material. For example, the invention establishes a communication session directly between the requestor and the provider of a virtual document (e.g., a PDF document) in order to get permission to reproduce the virtual document. Alternatively, a web site that provides a link to a virtual document establishes a session with the provider to get permission to reproduce the virtual document.

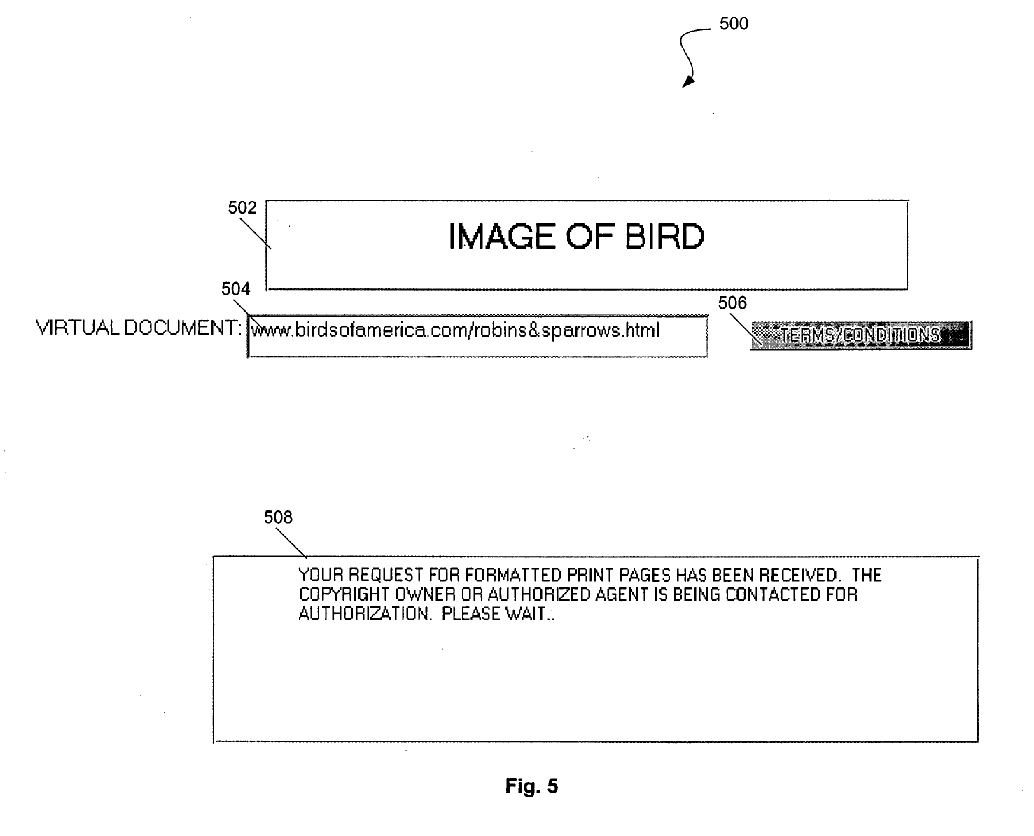

Further, the present invention includes communicating with an end-customer. FIG. 5 illustrates an example display screen 500 that is provided to a user who requests formatted print pages. In the example shown in FIG. 5, an image 502 of a bird is displayed, and an internet uniform resource locator (URL) 504 is similarly displayed that represents the location where the image is stored. In the example shown in FIG. 5, a web page depicting robins and sparrows is provided at the uniform resource locator, www.birdsofamerica.com/robins&sparrows.html.

Continuing with the example display screen 500 in FIG. 5, a graphical screen control 506 is formatted as a button and provided that, when selected, displays terms and conditions associated with the order for formatted print pages. Moreover, a message area 508 is displayed that informs the customer that a request for a printed copy of the virtual document may result a delay in delivery of formatted print pages due to a requirement to secure permission to reproduce the copyrighted material. Alternatively, in case permission authorizing the reproduction of a virtual document is transmitted by, for example, the copyright holder, the present invention informs the requesting customer that permission to reproduce the copyrighted material has been received and that the order is being processed.

Also in a preferred embodiment, the present invention is operative to add or remove the display of one or more graphical screen controls, such as buttons, icons, hyperlinks or other controls that offer an end user formatted print pages (e.g., formatted in a bound printed copy of the virtual document) from content 3 in a display screen that represents or displays the virtual document (not shown). For example, in case permission to reproduce a virtual document has been denied or not yet obtained from a copyright owner, the present invention can disable or hide the controls that are operative to initiate a request for formatted print pages for content 3 identified by or located in a display screen.

Preferably, the present invention also provides communicating via automatic, semi-automatic or entirely manual ways with the identified copyright owner, the owner's authorized agent or other possible copyright holders in order to seek permission to print or otherwise make a copy of the virtual document. In a preferred embodiment, some offer is electronically transmitted to the copyright owner, such as for a royalty payment, in order to obtain permission to reproduce the copyrighted material.

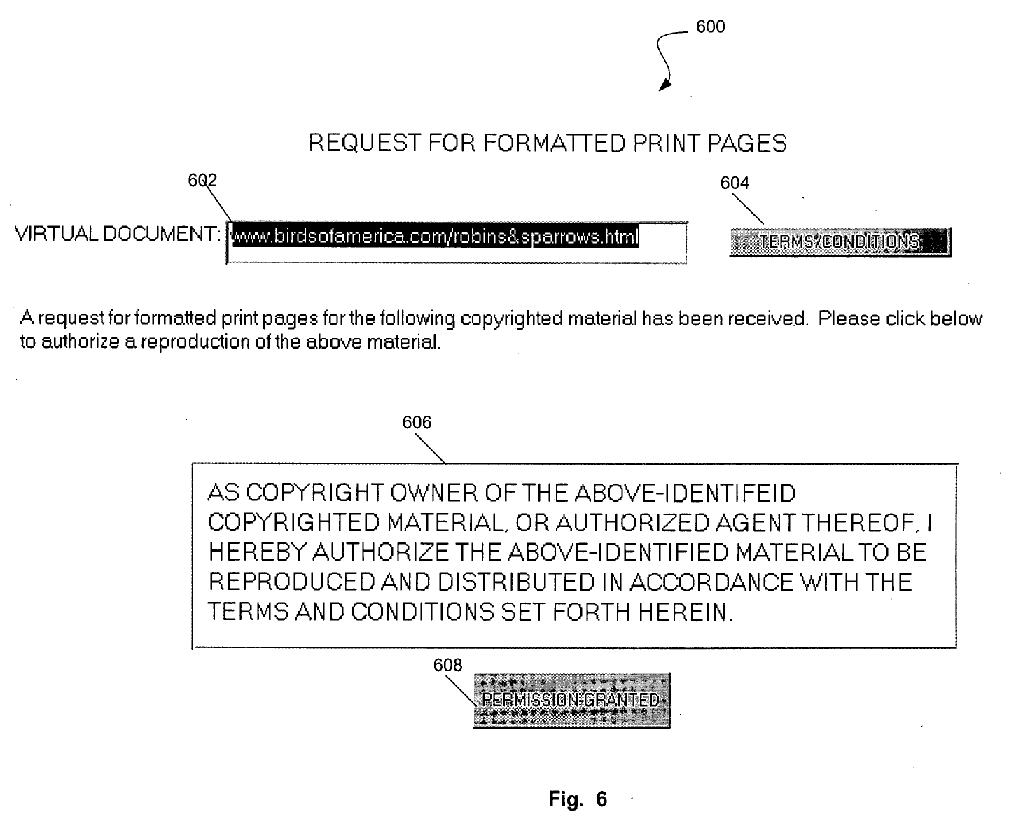

FIG. 6 illustrates an example display screen 600 which is provided to a copyright owner or authorized agent thereof in order to receive authorization for producing formatted print pages of copyrighted material, for example, in a virtual document. In the example shown in FIG. 6, URL 602 is provided which points to the same web page shown in FIG. 5, www.birdsofamerica.com/robins&sparrows.html. Further, terms and conditions button 604 is provided which, when selected, displays information regarding terms and conditions for providing authorization for providing formatted print pages. For example, terms and conditions may include a copyright royalty payment amount (for example, from data stored in copyright payment data table 412), a number of times a virtual document can be reproduced, and other related contractual and legal terms.

Continuing with the example display screen 600 shown in FIG. 6, message area 606 provides an affirmative statement that the copyright owner or authorized agent is authorizing use of the virtual document. Button 608 is preferably provide that, when selected, operates to transmit authorization by the copyright owner (or authorized agent) for producing formatted print pages of the virtual document. Although the example shown in FIG. 6 represents a virtual document (in this case, a web page) that is to be reproduced as formatted print pages, it is envisioned herein that the present invention is applicable for any copyrightable material that can be copied and/or reproduced. For example, an audio file may be stored on an internet server and available over the World Wide Web. A user of the present invention can seek permission, and permission can be granted by an authorizing party to copy the audio file. Thus, the description of the present invention is not intended to limit or reduce the scope of the invention to virtual documents and/or formatted print pages.

Further, the present invention includes searching the internet and/or World Wide Web for virtual documents (e.g., PDF documents), on any or selected web sites, or any other location where virtual documents are stored, for which permission to reproduce a virtual document has not yet been secured. In an embodiment, the present invention requests such permission prior to any request from an end user has been generated for reproduction of virtual documents as formatted print pages. For example, the present invention includes a means for recording and tracking such requests in a database, and references the database 17 to determine whether permission to reproduce virtual documents as formatted print pages has been obtained.

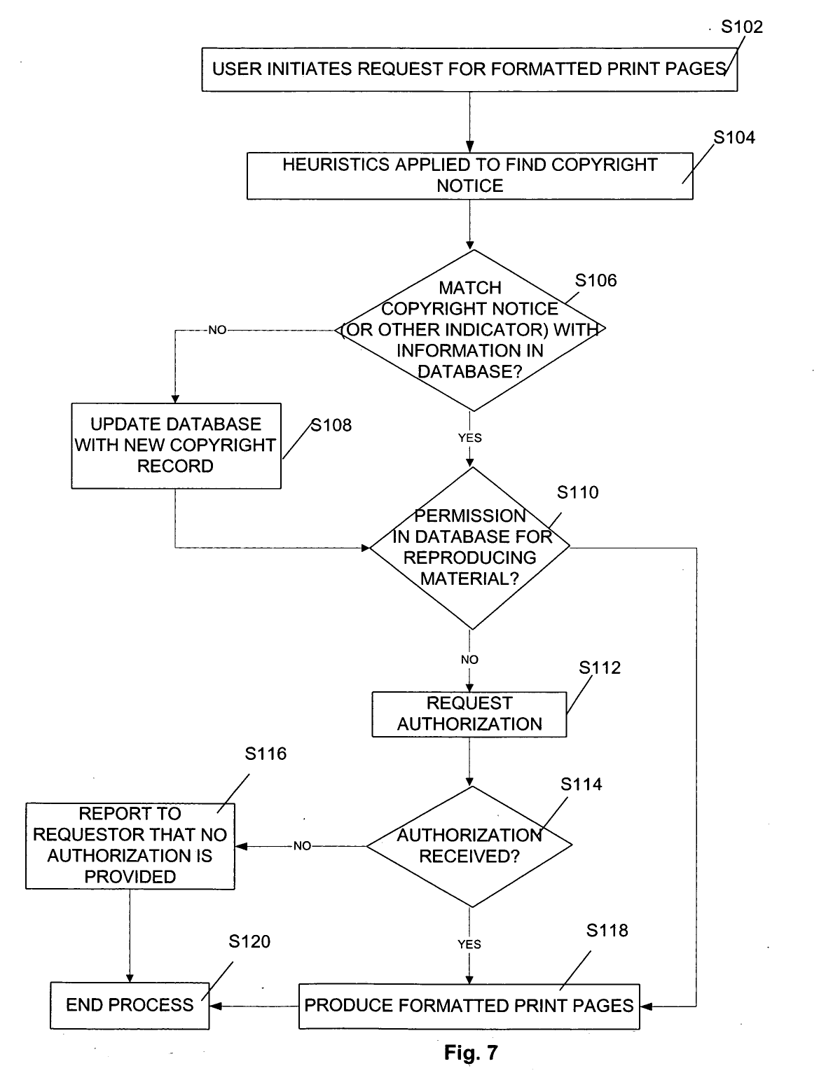

FIG. 7 is a flow chart that illustrates example steps associated with a preferred embodiment. In step S102, a user, for example, operating a web browser software application requests an order for formatted print pages. The request is received and heuristics, such as described above, are applied in order to determine the location of a copyright notice (step S104). Database 17 is preferably referenced to determine whether the copyright notice (if found), or other indicator of the virtual document has been previously stored (step S106). If not, database 17 is preferably updated with information regarding the virtual document (or other electronic content 3) (step S108). If a record is found that matches the copyright notice, then in step S110 a query is made to determine whether permission to reproduce the requested virtual document has already been received.

Continuing with reference to the flow chart in FIG. 7, in case no record of permission to reproduce the virtual document has been determined in step S110, then a request for authorization is preferably transmitted to the copyright owner (or authorized agent thereof) (step S112). For example and as shown in FIG. 6, a communication session is preferably established with the copyright owner (or authorized agent thereof) and a form is provided that enables the owner/agent to authorize use of the virtual document (or other content 3) in some form. In step S114, a determination is made whether authorization has been received. If not, then in step S116 the user is informed that authorization has not been received and the process terminates at step S120. If authorization is received, then in step S118, formatted print pages are produced. Similarly, if in step S110 a determination is made that permission for producing formatted print pages comprising the content 3, for example in a virtual document is stored in database 17, then the process branches to step S118 and formatted print pages are produced. Thereafter, the process terminates at step S120.

Thus, in a particular embodiment, the present invention provides a new way to provide formatted print pages comprising content 3 from virtual documents. More particularly, the invention manages information regarding permission to reproduce copyrighted material, for example, in formatted print pages. The invention further provides ways to secure permission to reproduce virtual documents, enables or disables graphic screen controls that are operative to request formatted print pages, and provides messages to requestors of formatted print pages regarding the status of a request for formatted print pages.

Other uses and products provided by the present invention will be apparent to those skilled in the art. The present invention is applicable for securing copyright permission to reproduce any electronic content in any way. For example, permission for using a particular song in a collection can be secured according to the teachings herein. Alternatively, permission for making electronic copies of copyrighted material can be afforded according to the teachings here.

Thus, although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for securing authorization to include at least some of copyrighted content in electronic or physical form, the method comprising:
storing in a database electronic information representing electronic and physical content;
receiving a request for the electronic or physical form that includes the at least some of the copyrighted content;
determining whether the electronic information includes permission to include the at least some of the copyrighted content; and
providing the electronic or physical form when the electronic information includes permission to include the at least some of the copyrighted content.

2. The method of claim 1, further comprising requesting permission to provide the electronic or physical form when the electronic information does not include permission to include at least some of the copyrighted content.

3. The method of claim 2, wherein the step of requesting permission comprises electronically contacting an authorized agent or an owner.

4. The method of claim 3, wherein the step of requesting permission further comprises:
establishing a communication session with the copyright owner or an authorized agent thereof;
providing a display form requesting the permission, wherein the display form includes at least one graphical screen control enabling the copyright owner or the authorized agent to transmit the permission.

5. The method of claim 4, wherein the communication session is provided between the requestor for the electronic or physical form and the copyright owner or the authorized agent.

6. The method of claim 1, wherein the physical form comprises formatted print pages.

7. The method of claim 1, further comprising determining whether the copyrighted content includes a copyright notice.

8. The method of claim 1, further comprising substantially automatically updating the database with copyright information representing the copyrighted content.

9. The method of claim 1, further comprising providing an interface to a user for requesting the electronic or physical form.

10. The method of claim 9, wherein the interface identifies terms, conditions and/or costs associated with receiving the electronic or physical form.

11. The method of claim 9, further comprising preventing the user from performing the step of requesting the electronic or physical form when the electronic information indicates the permission is denied.

12. The method of claim 9, further comprising informing the user that the permission is being requested.

13. A system for securing authorization to include at least some of copyrighted content in electronic or physical form, the system comprising:
a database operable on a computer system;
electronic information stored in the database, wherein the electronic information represents electronic and physical content;
a request receiving module operable to receive a request for the electronic or physical form that includes the at least some of the copyrighted content, wherein the request receiving module is further operable to determine whether the electronic information includes permission to include the at least some of the copyrighted content; and
a fulfillment facility that provides the electronic or physical form when the electronic information includes permission to include the at least some of the copyrighted content.

14. The system of claim 13, further comprising a request permission module operable to request permission for the electronic or physical form when the electronic information does not include permission to include at least some of the copyrighted content.

15. The system of claim 14, wherein the request permission module electronically contacts an authorized agent or an owner.

16. The system of claim 15, further comprising:
a communication session with the copyright owner or an authorized agent thereof and provided by the request permission module,
a display form displayed during the communication session and operable to request the permission, wherein the display form includes at least one graphical screen control enabling the copyright owner or the authorized agent to transmit the permission.

17. The system of claim 16, wherein the communication session is provided between the requestor for the electronic or physical form and the copyright owner or the authorized agent.

18. The system of claim 13, wherein the physical form comprises formatted print pages.

19. The system of claim 13, wherein the copyrighted content is reviewed for a copyright notice.

20. The system of claim 13, wherein the database is substantially automatically updated with copyright information corresponding to the copyrighted content.

21. The system of claim 13, further comprising an interface provided to a user for requesting the electronic or physical form.

22. The system of claim 21, wherein the interface identifies terms, conditions and/or costs associated with receiving the electronic or physical form.

23. The system of claim 21, wherein the interface prevents the user from requesting the electronic or physical form when the electronic information indicates the permission is denied.

24. The system of claim 21, further wherein the interface informs the user that the permission is being requested.
